(19) United States
(12) Patent Application Publication
(10) Pub. No.: US 2025/0247374 A1
(43) Pub. Date: Jul. 31, 2025

(54) SYSTEMS AND METHODS FOR DECENTRALIZED DATA SHARING

(71) Applicants: The MITRE Corporation, McLean, VA (US); The Department of Homeland Security, Washington, DC (US)

(72) Inventors: John Michael HOWARD, Clinton, MA (US); Alexandria PHOUNSAVATH, Fairfax, VA (US); Jeffrey Kyle SCHWEFLER, Dunstable, MA (US); Garfield St. Aubyn JONES, Germantown, MD (US); Mario Hector AYALA, JR., Stafford, VA (US)

(73) Assignees: The MITRE Corporation, McLean, VA (US); The Department of Homeland Security, Washington, DC (US)

(21) Appl. No.: 19/037,858

(22) Filed: Jan. 27, 2025

Related U.S. Application Data
(60) Provisional application No. 63/625,570, filed on Jan. 26, 2024.

(51) Int. Cl. H04L 9/40

(52) U.S. Cl. CPC H04L 63/0428

(57) ABSTRACT

An exemplary method comprises: transmitting, by a first edge node, a request for a data object to a web service; receiving, by the web service, the request for the data object; determining, by the web service, based on the request, an identity of a second edge node that has the data object, wherein the identity of the second edge node is determined from a database that associates data objects with edge nodes; transmitting, by the web service, a request to share the data object with the first edge node to the second edge node; and transmitting, by the second edge node, a copy of the data object to the first edge node based on the request from the web service.

### CROSS REFERENCE TO RELATED APPLICATIONS

This application claims priority to U.S. Provisional Application Ser. No. 63/625,570, filed Jan. 26, 2024, the entire contents of which are incorporated herein by reference.

### STATEMENT OF FEDERALLY SPONSORED RESEARCH OR DEVELOPMENT

This invention was made with Government support under contract number 70RSAT20D00000001, awarded by the Department of Homeland Security. The Government has certain rights in the invention.

### FIELD

The present disclosure relates generally to data sharing and more specifically to managing distribution and access to data.

### BACKGROUND

As the generation, collection, use, and storage of data continues to grow, so does the threat of data being misused, stolen, or unintentionally released, causing harm to both individuals and organizations. Data sharing can unleash benefits that improve outcomes across society and the economy. However, with these benefits come risks. Today, consent for data use when users purchase products or services is often in fine print, legal jargon, or is otherwise opaque to users. This lack of transparency means that entities collect data without the users' full awareness of how their data will be used. Organizations who rightfully own or use data must also be able to protect and defend their networks and create controls for data access to prevent sensitive data from misuse, theft, and unintended disclosure. Concurrently, such organizations must defend their network and system domains using access and usage controls to prevent sensitive data from unintended use, theft, and disclosure. Cybersecurity has become a national and international priority, and cybersecurity spending has increased greatly in response to cybercrime. Yet, once a breach occurs, data is compromised leading to harmful and expensive consequences.

### SUMMARY

According to various embodiments, systems, methods, devices, and non-transitory computer readable storage media described herein change the paradigm for users and organizations by enabling them to exert increased control over their data. The data owners may define who can see their data, what data can be seen by specific requestors, where data can be stored and for how long, who can use the data with or without economic recompense, and more. Data objects may be configured to interact automatically and assert and enforce the requirements of the owner throughout the data object's life. For instance, data objects can be “self-aware” and act autonomously using attributes contained within the data object that define the parts of the data object that may be seen, stored, accessed, and/or used (including for how long such parts may be seen, stored, accessed, and/or used). The data objects may maintain a transaction log capturing how its elements have been modified, transformed, updated, and/or enriched. Data objects described herein may “interact” in a robust technology ecosystem that increases cyber resilience, protects individual and organizational data assets, and increases transparent and trusted use of data which in turn will benefit all sectors of the economy and society. Additionally, this disclosure supports aspirations for Web3, where the goal is to create a user-centric, secure, and decentralized internet.

According to various embodiments, systems, methods, devices, and non-transitory computer readable storage media for brokering access to a data object are optimized for decentralized processing, such as edge computing, by equipping data objects themselves with the tools needed for edge processing. Systems and methods aim to address the limitations associated with centralized data processing in cloud or physical data centers. In the distributed and/or edge computing model, data processing and analysis occur closer to the data source or “edge” of the network, rather than being transmitted to a centralized data center. This approach offers several advantages, including reduced latency, enhanced privacy, and decreased bandwidth usage. By processing data locally, edge computing enables real-time data analysis, making it particularly beneficial for applications requiring instant decision-making, such as disaster response, medical treatment, border security, smart cities, and Internet of Things (IoT) devices. Moreover, by decentralizing data storage and processing, edge computing enhances security by dispersing the risk of potential cyber-attacks. In essence, edge computing fosters a more efficient, responsive, and secure data processing ecosystem, addressing the escalating demands of an increasingly connected world.

According to some embodiments, the systems and methods described herein enable storage and processing of data objects, for instance, at edge nodes based on processing instructions included in the data objects themselves, as well as shared access to copies of data objects across a network without requiring centralized storage or compute, and thus, without requiring use of expensive and energy-consuming data centers required for data storage and processing. The systems and methods described herein may include a data registrar service that keeps a registry of data objects and their owners. Once registered with the data registrar service, the data object is locatable by authorized edge devices and/or users connected to the ecosystem. Authorized edge devices and/or users may request a copy of a data object by transmitting a request to the data registrar service, which the data registrar service may route to the data owner device. If the request is approved by the data owner, a copy of the data file may be transmitted to the requestor device. Changes to the data object (e.g., made by the requestor device) may be recorded in a ledger of the copy of the data object and synchronized with the original data object at the owner device and/or other copies designated by the data owner.

Additionally, an encryption service, referred to herein as a key registrar service, controls access to data by enabling creation, storage, and sharing of cryptographic keys that provide varying degrees of access to data objects based on instructions included in the data objects and/or the identities of requestors, etc. Accordingly, the data objects described herein may be encrypted or include encrypted portions, and to decrypt a copy of the data, the requestor may request at least one cryptographic key from the key registrar service. The key registrar service may respond with one or more keys that the requestor may use to decrypt the data object or portions of the data object. Optionally, the key registrar may maintain different keys for a data object that provide differing levels of access. The data registrar may determine which keys to provide based on cryptography information obtained from the cryptography module of the data object. Additionally, or alternatively, the data registrar may determine which keys to provide based on the identity of the requestor.

As noted above, the data objects stored and processed at edge nodes of the exemplary systems described herein include both data as well as a variety of processing instructions (e.g., processing instruction modules) configured to instruct devices, applications, web services, and so on how to process the data in the data object. Accordingly, rather than configuring various custom applications (e.g., web or mobile applications) for processing the data in the data object, the data objects described herein provide the processing instructions (e.g., visualization instructions, handling instructions, compute instructions, etc.), for instance, to a processing engine at each respective edge device, and the processing engine executes the instructions stored in the data object. In some embodiments, to create a data object, a user may download a data template from a service provider, modify the template using a software engine at their device to create the data object, and then register the data object with at least one web service, including the key registrar service that provides cryptographic keys to authorized users wishing to access the data object and the data registrar service that assists those authorized users with locating and obtaining a copy of the data object described above.

While the systems, methods, devices, and non-transitory computer readable storage media disclosed herein are described with reference an edge computing embodiment, where the deployment consists of systems, methods, devices, and non-transitory computer readable storage media for data processing across the internet, internet of things, or similarly distributed compute scenario and where edge may be defined as computing equipment connected to the network such as laptops, desktops, mobile devices, servers, virtual cloud resource, or other purpose built appliances. However, the disclosure is not limited to edge computing. The disclosure can be applied to systems, methods, devices, and non-transitory computer readable storage media in a non-distributed scenario such as a single cloud or on-premises network belonging to a single, or multiple, organization(s).

According to an aspect, an exemplary method for sharing data between edge nodes of a data communication network comprises: transmitting, by a first edge node, a request for a data object to a web service; receiving, by the web service, the request for the data object; determining, by the web service, based on the request, an identity of a second edge node that has the data object, wherein the identity of the second edge node is determined from a database that associates data objects with edge nodes; transmitting, by the web service, a request to share the data object with the first edge node to the second edge node; and transmitting, by the second edge node, a copy of the data object to the first edge node based on the request from the web service.

Optionally, the second edge node is an edge device associated with an owner of the data object. Optionally, transmitting, by the second edge node, the copy of the data object to the first edge node based on the request comprises transmitting, by second edge node, the copy to the web service and transmitting, by the web service, the copy to the first edge node.

Optionally, the method comprises: comprising: decrypting, at the first edge node, at least a portion of data in the copy of the data object using at least one cryptographic key obtained using cryptography information included in the copy of the data object, wherein the at least one cryptographic key was obtained by transmitting, by the first edge node, a request for the at least one cryptographic key to a key registrar service, the request for access comprising identity information associated with the first edge node and the cryptography information included in the copy of the data object.

Optionally, the data object comprises processing instructions for processing data in one or both of the data object and the copy of the data object. Optionally, the processing instructions comprise at least one of: instructions for prompting a device for payment for processing the data in the data object; instructions for visualizing the data in the data object; instructions for recording updates to the data in the data object to a ledger, the ledger included in the data object; a temporal, geographic, device specific, or user specific limit for accessing the data in the data object; instructions for calling a compute resource for processing the data; instructions prohibiting transmission of the data object to one or more devices; instructions for viewing or processing the data according to a predefined sequence of processing steps; instructions for encrypting and decrypting at least a portion of the data; instructions for augmenting the data based on predefined algorithms or compute resources; and instructions for performing an action based on a condition being satisfied. Optionally, the compute resource comprises a computer program configured to process the data. Optionally, the condition comprises any one or more of: one or more conditions specified in the data object; the first edge node entering a certain geographic location; the first edge node receiving a request to access the data; or a step of a plurality of steps associated with processing the data object at the first edge node the data being completed. Optionally, the action comprises transmitting an alert to other edge nodes, users, and/or web services. Optionally, the copy of the data object comprises a copy of the processing instructions.

Optionally, the method comprises: processing, at the first edge node, the decrypted portion of the data in the copy of the data object based on one or more of the processing instructions included in the copy of the data object. Optionally, processing the decrypted portion of the data in the copy of the data object comprises at least one of: adding data to the data object, deleting at least a portion of the data from the data object, and modifying at least a portion of the data included in the data object. Optionally, processing the decrypted portion of the data in the copy of the data object comprises at least one of: adding processing instructions to the copy of the data object, deleting processing instructions from the copy of the data object, and modifying processing instructions included in the copy of the data object.

Optionally, the method comprises determining, by the first edge node, that processing the copy of the data object resulted in a change to the data in the copy of the data object; recording the change to the data to a ledger in the copy of the data object; and transmitting an alert to the second edge node based on the change to the data. Optionally, the method comprises: determining that the data object includes a synchronization instruction to update the data object based on the change to the data in the copy of the data object; and updating the data in the data object based on the change to the data in the copy of the data object. Optionally, the data object comprises any one or more of a medical record, an electronic passport, an employee record, an electronic student identification, and a tax record. Optionally, the first edge node comprises a medical device. It should be understood that the data object may include any type of data and the aforementioned medical record, electronic passport, employee record, electronic student identification, and tax record are merely provided as illustrative examples.

According to an aspect, an exemplary system for sharing data between edge nodes of a data communication network comprises: a first computing system comprising one or more processors and memory storing one or more computer programs that include computer instructions, which when executed by the one or more processors, cause the first computing system to: transmit, by a first edge node a request for a data object to a web service; a second computing system comprising one or more processors and memory storing one or more computer programs that include computer instructions, which when executed by the one or more processors, cause the second computing system to: receive, by the web service, the request for the data object; determine, by the web service, based on the request, an identity of a second edge node that has the data object, wherein the identity of the second edge node is determined from a database that associates data objects with edge nodes; transmit, by the web service, a request to share the data object with the first edge node to the second edge node; and a third computing system comprising one or more processors and memory storing one or more computer programs that include computer instructions, which when executed by the one or more processors, cause the third computing system to: transmit, by the second edge node, a copy of the data object to the first edge node based on the request from the web service.

Optionally, the second edge node is an edge device associated with an owner of the data object. Optionally, transmitting, by the second edge node, the copy of the data object to the first edge node based on the request comprises transmitting, by the second edge node, the copy to the web service and transmitting, by the web service, the copy to the first edge node. Optionally, the computer instructions stored in the memory of the first computing system, when executed by the one or more processors, cause the first computing system to: decrypt, at the first edge node, at least a portion of data in the copy of the data object using at least one cryptographic key obtained using cryptography information included in the copy of the data object, wherein the at least one cryptographic key was obtained by: transmitting, by the first edge node, a request for the at least one cryptographic key to a key registrar service, the request for access comprising identity information associated with the first edge node and the cryptography information included in the copy of the data object.

Optionally, the data object comprises processing instructions for processing data in one or both of the data object and the copy of the data object. Optionally, the processing instructions comprise: instructions for prompting a device for payment; instructions for visualizing the data in the copy of the data object; instructions for recording updates to the data in the copy of the data object to a ledger, the ledger included in the copy of the data object; a temporal, geographic, device specific, or user specific limit for accessing the data in the copy of the data object; instructions for calling a compute resource for processing the data included in the copy of the data object; instructions prohibiting transmission the copy of the data object to one or more devices; instructions for viewing or processing the data included in the copy of the data object according to a predefined sequence of processing steps; instructions for encrypting and decrypting at least a portion of the data included in the copy of the data object; instructions for augmenting the data included in the copy of the data object based on predefined algorithms or compute resources; or instructions for performing an action based on a condition being satisfied. Optionally, the compute resource comprises a computer program configured to process the data. Optionally, the condition comprises: one or more conditions specified in the data object; the first edge node entering a certain geographic location; the edge node receiving a request to access the data; or a step of a plurality of steps associated with processing the data object at the first edge node being completed. Optionally, the action comprises transmitting an alert to other edge nodes, users, and/or web services. Optionally, the copy of the data object comprises a copy of the processing instructions.

Optionally, the computer instructions stored in the memory of the first computing system, when executed by the one or more processors, cause the first computing system to: process, at the first edge node, the decrypted portion of the data in the copy of the data object based on one or more of the processing instructions included in the copy of the data object. Optionally, processing the decrypted portion of the data in the copy of the data object comprises at least one of: adding data to the data object, deleting at least a portion of the data from the data object, and modifying at least a portion of the data included in the data object. Optionally, processing the decrypted portion of the data in the copy of the data object comprises at least one of: adding processing instructions to the copy of the data object, deleting processing instructions from the copy of the data object, and modifying processing instructions included in the copy of the data object.

Optionally, the computer instructions stored in the memory of the first computing system, when executed by the one or more processors, cause the first computing system to: determine, by the first edge node, that processing the copy of the data object resulted in a change to the data in the copy of the data object; record the change to the data to a ledger in the copy of the data object; and transmit an alert to the second edge node based on the change to the data. Optionally, the computer instructions stored in the memory of the first computing system, when executed by the one or more processors, cause the first computing system to: determine that the data object includes a synchronization instruction to update the data object based on the change to the data in the copy of the data object; and update the data in the data object based on the change to the data in the copy of the data object. Optionally, the data object comprises any one or more of a medical record, an electronic passport, an employee record, an electronic student identification, and a tax record. It should be understood that the data object may include any type of data and the aforementioned medical record, electronic passport, employee record, electronic student identification, and tax record are merely provided as illustrative examples.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

FIG. 1A illustrates an exemplary system for registering, managing access to, and synchronizing encrypted data objects according to some embodiments.

FIG. 1B illustrates a distributed network of ecosystems for registering, managing access to, and synchronizing encrypted data objects according to some embodiments.

FIG. 2 illustrates an exemplary data object stored at a software engine of an edge device according to some embodiments.

FIG. 3 illustrates an exemplary process for acquiring and registering an intelligent data engine and creating a data object according to some embodiments.

FIG. 4 illustrates an exemplary process for visualizing and modifying a data object according to some embodiments.

FIG. 5 illustrates an exemplary process for registering a data object with a key registrar service and a data registrar service according to some embodiments.

FIG. 6 illustrates an exemplary process for sharing and managing access to a data object according to some embodiments.

FIG. 7 illustrates an exemplary method for processing a data object using a software engine at an edge device according to some embodiments.

FIG. 8 illustrates an exemplary computing system according to some embodiments.

FIG. 9 illustrates exemplary capabilities of a data object according to some embodiments.

FIG. 10 illustrates a flowchart representing an exemplary process for sharing and processing a data object according to some embodiments.

### DETAILED DESCRIPTION

Disclosed herein are examples of systems, methods, devices, and non-transitory computer readable storage media directed generally to decentralized data sharing of data objects configured to provide data owners with control over their data and optimized for distributed computing by equipping the data object itself with the tools needed for processing, for instance, at a plurality of devices such as edge devices in a distributed network and/or devices connected to a single cloud or on-premises network belonging to a single, or multiple, organization(s). To carry out the processing instructions included in the data objects described herein, decentralized data sharing ecosystems, including various computing systems, web services, software engines, and/or other interconnected tools used to discover, collaborate, analyze, and/or share data (including data objects) from various sources are provided. A data object may be registered with one or more web services configured to enable edge devices to locate, access, and decrypt the data object. For example, the data object(s) may be registered with a data registrar service configured to store location information associated with the data object and may broker access to the data object by routing access requests between a requestor device and a data owner device, which may both be edge devices. To register the data object with the data registrar service, a first edge device (or other type of electronic device) may transmit location information of the data object (e.g., a unique identifier associated with the data object and/or software engine, and/or computing network location information for the data object including a location of an edge device storing the data object in the computing network) to the data registrar service. The data registrar service may then store the location information in association with an identifier of the data object in a data registry (e.g., a datastore).

To enable encryption and decryption of the data objects (or portions thereof), the data object may further be registered with a key registrar service that is configured to store and transmit cryptographic keys for decrypting the data object to authorized users. To register the data object, an edge device (e.g., a data owner's device) may request a unique identifier from a key registrar service associated with a respective ecosystem and generate cryptographic keys based on the unique identifier obtained from the registrar service. The cryptographic keys may be returned to the key registrar service so that they can later be provided to authorized devices such as other edge devices requesting access to copies of the data object to decrypt the copies of the data object or revoked as described by the key registrar service (e.g., the key registrar service may be configured to revoke key access in some instances).

Once the registration process is complete, the data object becomes part of a respective ecosystem, and other authorized users and devices may locate, request access to, and interact with copies of the data object using the web services and software engines associated with the ecosystem. In some embodiments, requests for access to a data object may be transmitted from a software engine running on an edge device to the data registrar service, which may then route the request to the data owner device. If a software engine at the owner device validates the software engine at the requestor device, and the data owner approves the request for access, then the owner device may transmit a copy of the data object or at least a portion of the data object to the data registrar service, which may in turn transmit the copy to the requestor device. Alternatively, the owner device may transmit the copy of the data object directly to the requestor device. The data owner device may retain the original data object (e.g., only copies may be transmitted to the requesting edge devices) or transmit a copy where changes are synchronized with the original data object. In some examples, the original data object retained by the owner device may itself be a copy of the data object that was received from another device.

To access the data or other features included in the data object, the requestor device may be required to decrypt various aspects of the data object using cryptographic keys obtained from the key registrar. The keys provided by the key registrar may be specific to the requesting user, requesting device, requesting software engine, and so on. Accordingly, different users, devices, etc. may be provided with different access privileges to the data object or to portions of the data object. Thus, data owners are provided with heightened control over their data, having the ability to encrypt their data object at any level of the data hierarchy in the data object (e.g., by restricting access to different files, different functionality, etc.).

If the requesting device manipulates the data object such that any changes (e.g., additions, deletions, modifications) result to the data object, the software engine at the requesting/manipulating device may be configured to record those changes to a ledger module of the data object. Further, the software engine at the requesting/manipulating device may be configured to alert the data owner and/or synchronize one or more copies of the data object (including the original) stored at various locations/devices within the ecosystem and/or across ecosystems by transmitting the updates, changes, etc. to the software engines storing other copies of the data object.

As described herein, a data object includes both data and a variety of processing instructions for processing the data (e.g., visualizing, manipulating, or otherwise interacting with the data). The processing instructions may be provided in discrete modules within the data object. Examples of such modules include an identity module, a billing module, a visualization module, a registration module, a cryptography module, a compute module, a schema module, a ledger module, a handling module, and a data module. A data object may include any of these modules and may include other modules. Each module may include information/instructions associated with certain processing tasks performed in relation to the data object. For instance, the billing module may include instructions that prompt a device/user for payment to process the data object. This may provide a data owner with additional control over their data and ensure that the owner is compensated when their data is used by others. The data object may be configured to prompt a device for different payments based on processing tasks, the data being accessed, etc.

To create a data object, a user may obtain and modify a data template. To obtain the data template, the user (e.g., data owner) may first obtain one or more software engines, for instance, an intelligent data engine and visualization engine (e.g., from an ecosystem or data registrar administrator). The intelligent data engine and visualization engine are software engines that a user may download and install at their respective devices and which may include components for, creating, registering, accessing, modifying, and/or processing the data objects and interacting with other components of the ecosystem (e.g., other devices and web services). Once the intelligent data engine and visualization engine are installed at a user device, a data template may be obtained from an ecosystem administrator and modified using the intelligent data engine and visualization engine to create a data object. In some examples, a data template may be obtained from a data registrar using the data registrar service and modified using the intelligent data engine and visualization engine to create a data object.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like refer to the actions and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

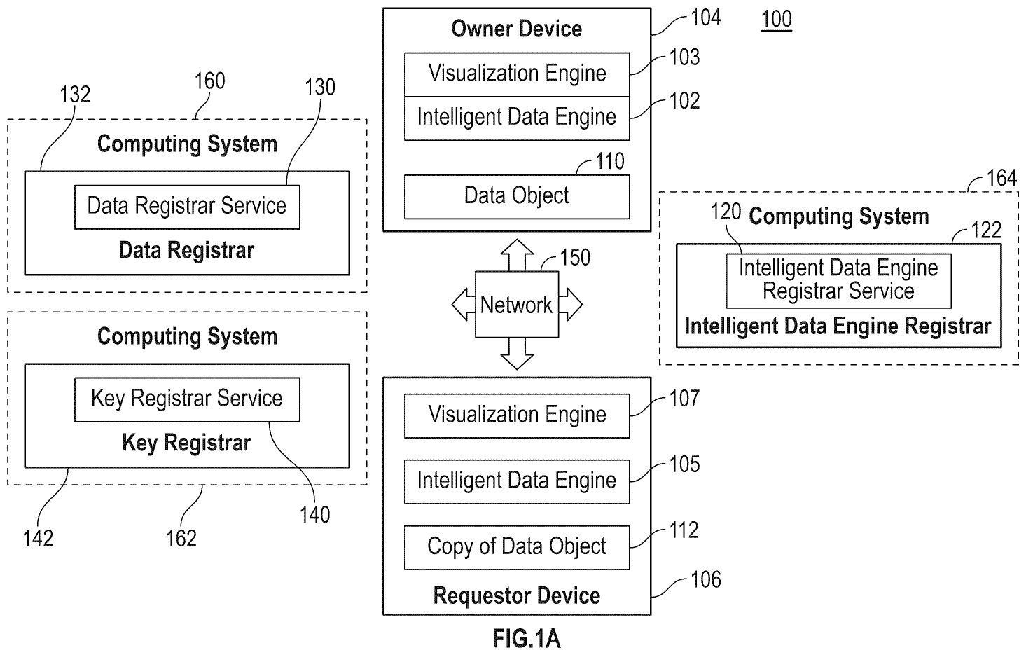

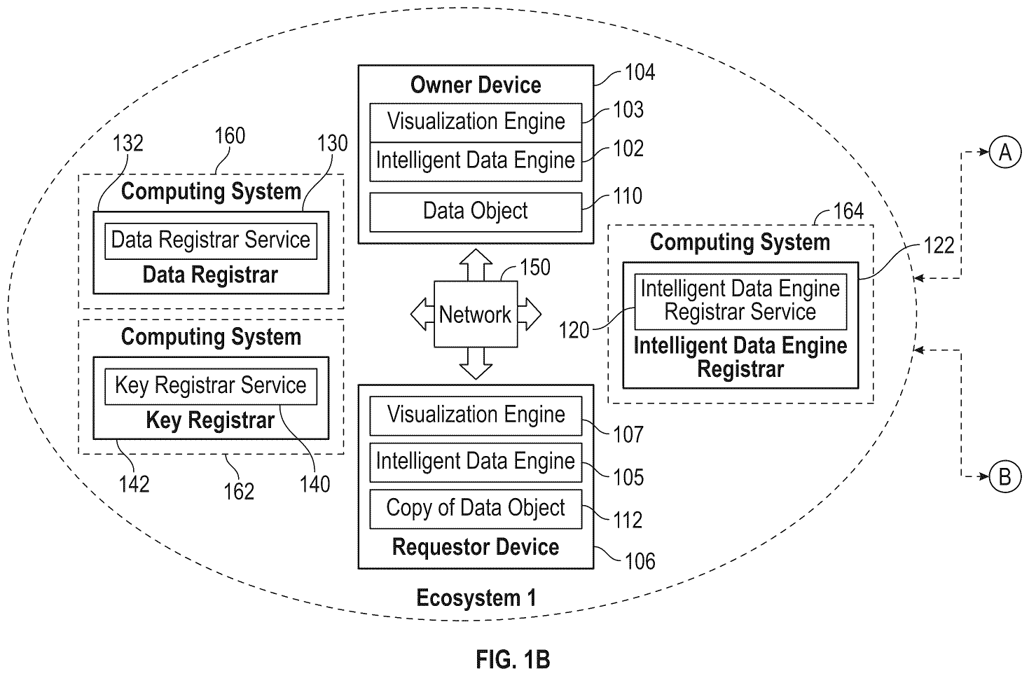

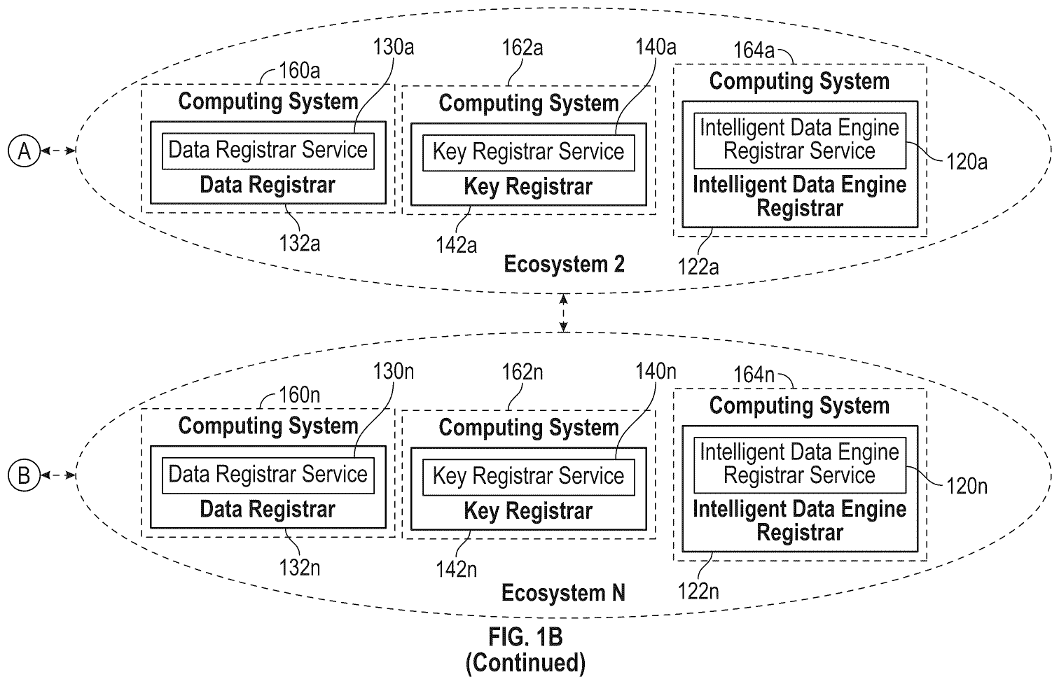

FIG. 1A illustrates a system 100 for sharing data between edge nodes of a data communication network. System 100, according to some embodiments, is configured to enable edge devices to interact with (e.g., create, register, share, modify, synchronize, etc.) one or more data object(s) 110. For example, a requestor edge device 106 may request a data object 110 from an owner edge device 104 by sending a request over one or more networks 150. The owner edge device 104 may determine whether the requestor edge device is authorized to access the data object, and if it is, may transmit a copy of the data object 112 to the requestor edge device 106. As an example, the data object may include a medical record, the requestor edge device may be an MRI machine, and the owner edge device may be a mobile phone. The MRI machine may request a copy of the owner's medical record, and the owner edge device may transmit a copy of a data object including the medical record to the MRI machine.

To enable this interaction between the two (or more) edge devices 104 and 106, for instance, the MRI machine, and the mobile phone, the system may include one or more computing systems 160, 162, and 164 communicatively coupled to edge devices 104 and 106 via the one or more networks 150 using any wired or wireless communication protocol or combinations thereof. The computing systems 160, 162, and 164 may respectively host web services. For example, to route data object requests from requestor device 106 to owner device 104, and to facilitate transfer of copies of data objects 112 between edge devices, system 100 may include a data registrar service 130. The data registrar service 130 may be configured to register the location of a data object, for instance, in a data registrar 132, and to route requests for access to the object 110 between requestor devices 106 and owner devices 104 (e.g., to preserve the anonymity of the owner device), as well as to transmit a copy of the data object received from the owner device 104 to the requestor device 106. While system 100 is described as having a separate computing system (e.g., 160, 162, and 164) hosting each of the web services, it should be understood that any one or more of the web services may be hosted by the same computing system and/or that all of the web services may be hosted by the same computing system. Accordingly, the web services may be hosted on the same physical computing system or across a distributed network of computing systems.

In some embodiments, the data object 110 and the copy of the data object 112 are encrypted or include at least one or more encrypted portions. Accordingly, system 100 may include one or more web services for facilitating the decryption of data objects 110, copies of data objects 112, and/or portions thereof. For instance, upon receiving a copy of a data object 112, the requestor device 106 may require one or more cryptographic keys to decrypt at least a portion of the copy of the data object 112. In some embodiments, those keys are stored in a key registrar 142 of a key registrar service 140, and the requestor device may transmit a request for one or more keys based at least in part on information included in the copy of the data object 112. The key registrar service 140 may be configured to store cryptographic keys associated with data objects 110 and copies of data objects 112, for instance, in a key registrar 142, and to transmit keys to requestor devices upon approval from an owner device. The keys may provide varying levels of access based on the information included in the copy of the data object and/or based on an identity associated with the requestor. For instance, continuing with the medical record example described above, a device associated with primary care provider may be provided with a different set of keys, and thus different decryption capabilities from, for example, a device associated with a medical research facility or physical therapist.

As described above, device 104 and device 106 may both be edge devices. For instance, device 104 and/or device 106 may be any of a mobile phone, a laptop, a tablet, or other similar electronic device. Device 104 and/or device 106 may an IoT-connected device, such as a piece of medical equipment, a consumer appliance, a server, or other internet-connected and/or network connected device. It should be understood that device 104 and device 106 may respectively be any device capable of running one or more software engine(s) and communicating using one or more wired or wireless communications protocols. While FIG. 1A depicts a system including two edge devices, it should be understood that any number of devices may form part of system 100. In some embodiments, device 104 and device 106, respectively, include one or more software engine(s), such as an intelligent data engine 102 or 105 and/or visualization engine 103 or 107, communicatively coupled to the one or more web services (e.g., the data registrar service 130, key registrar service 140, and an intelligent data engine registrar service 120) over a network 150 using one or more wired or wireless communications protocols. The software engines installed on each of the respective edge devices may be configured to process data objects based on processing instructions included in the data objects, as described in further detail below. In other words, the edge devices 104 and 106 may be respectively configured with software engines to enable edge processing of the data objects described herein.

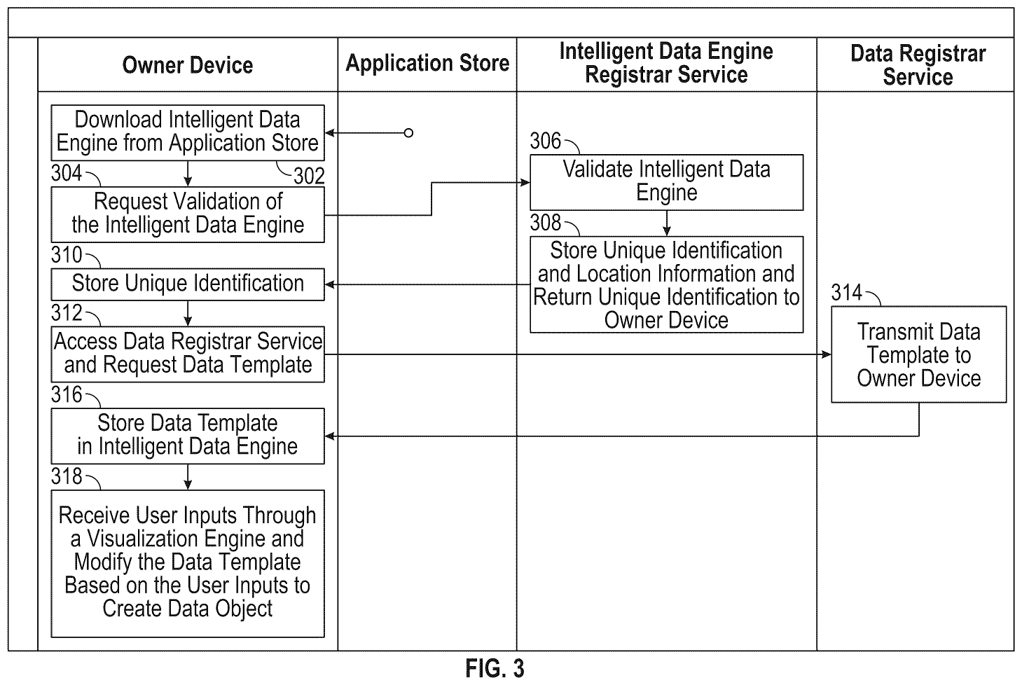

In some embodiments, one or more of the software engines are registered with one or more of the web services. For instance, in some embodiments, an intelligent data engine 102 provided on device 104 and intelligent data engine 105 provided on device 106 are respectively registered with the intelligent data engine registrar service 120 of computing system 164. The intelligent data engine registrar service 120 may be configured to receive registration and authentication requests from a device running an intelligent data engine 102 or 105. The intelligent data engine registrar service 120 may determine whether the intelligent data engine 102 or 105 is associated with a certified/trusted source before registering it with the system (e.g., with a respective ecosystem), for instance, as described in further detail below with reference to FIG. 3, by registering the intelligent data engine 102 or 105 in an intelligent data engine registrar 122.

While FIG. 1A depicts a single data registrar service 130 and data registrar 132 and a single key registrar service 140 and key registrar 142, it should be understood that a plurality of data registrars, data registrar services, key registrars, and/or key registrar services may be included in system 100, each of which may be associated with one of a plurality of respective ecosystems. As used herein, an ecosystem may refer to a collection of interconnected tools, infrastructure, devices, and applications used to discover, collaborate, analyze, and share data from various sources. An ecosystem may be associated with a particular organization (e.g., the IRS, FEMA, etc.), a particular objective (e.g., disaster response), etc.

FIG. 1B illustrates a distributed network of distributed ecosystems, including ecosystem 1, ecosystem 2, and ecosystem N, that may be included in system 100. Each ecosystem may include one or more respective data registrars, data registrar services, key registrars, and/or key registrar services. For instance, each of ecosystems 1, 2, through N may include any of the aspects of system 100 described above with reference to FIG. 1A. Ecosystem 2 may include one or more computing systems 160a, 162a, and 164a, and ecosystem N may include one or more computing systems 160n, 162n, and 164n. The one or more computing systems may be communicatively coupled to each other and to one or more edge devices via one or more networks using any wired or wireless communication protocol or combinations thereof (e.g., as described with reference to FIG. 1A).

The computing systems 160a, 162a, and 164a and/or 160n, 162n, and 164n may respectively host web services. For example, to route data object requests from a requestor device to an owner device, and to facilitate transfer of copies of data objects between edge devices, computing system 160a of ecosystem 2 may include a data registrar service 130a and computing system 160n of ecosystem N may include a data registrar service 130n. The data registrar service 130a and/or 130n may be configured to register the location of a data object, for instance, in a data registrar 132a or 132n, respectively, and to route requests for access to the object between requestor devices and owner devices (e.g., to preserve the anonymity of the owner device), as well as to transmit a copy of the data object received from the owner device to the requestor device.

Computing system 162a of ecosystem 2 and computing system 162n of ecosystem N may include a respective key registrar 142a and 142n of a key registrar service 140a and 140n. The key registrar service 140a and 140n may each be configured to store cryptographic keys associated with data objects and copies of data objects, for instance, in a key registrar 142a and 142n, respectively, and to transmit keys to requestor devices upon approval from an owner device. As discussed with reference to FIG. 1A, the keys may provide varying levels of access based on the information included in the copy of the data object and/or based on an identity associated with the requestor.

Computing system 164a of ecosystem 2 may include an intelligent data engine registrar service 120a and computing system 164n of ecosystem N may include an intelligent data engine registrar service 120n. The intelligent data engine registrar services 120a and 120n may be configured to receive registration and authentication requests from a device running an intelligent data engine. The intelligent data engine registrar service 120a and/or 120n may determine whether an intelligent data engine is associated with a certified/trusted source before registering it with the system (e.g., with a respective ecosystem, such as ecosystem 2 or ecosystem N) in a respective intelligent data engine registrar 122a or 122n.

As noted above, an ecosystem may be associated with a particular organization (e.g., the IRS, FEMA, etc.), a particular objective (e.g., disaster response), etc. As an example, ecosystem 1 depicted in FIG. 1B may include a passport data registrar service and may be configured to enable creation, sharing, modification, etc. of data objects comprising and/or serving as electronic passports. For instance, such data objects may be automatically accessed by devices and other services included in ecosystem 1, for instance, as user associated with a data object comprising an electronic passport enters a border crossing region, attempts to board an international flight, etc. As discussed further throughout, an electronic passport in the form of a data object could enable agencies to take automated actions based on passport actions and to correlate actions across agencies, among other beneficial features.

Ecosystem 2 may, for instance, include a medical data registrar service and may be configured to enable the creation, sharing, modification, etc. of data objects comprising and/or serving as electronic medical records. Such data objects may include, for instance, medical image data, physiological data, lab data, etc., associated with a particular patient/data owner and/or associated with a respective population of patients, etc. For instance, an organization may create a data object including medical data associated with one or more patient populations and may make the data object available within the ecosystem or across ecosystems with various processing instructions included as part of the data object. A data object configured with such medical data and processing instructions may ensure patient privacy, while enabling an organization to make sensitive data available, for instance, for training machine learning models, research, drug discover, and other activities. Exemplary processing instructions may include, but are not limited to, preventing transmission of the data object to different devices, cloud services, etc., billing enforcement modules that require payment for access to different portions of data, machine learning models and/or training algorithms, etc.

Ecosystem N may, for instance, include an IRS data registrar service and may be configured to enable the creation, sharing, modification, etc. of data objects comprising and/or serving as electronic tax records. An electronic tax record in the form of a data object disclosed herein could, like an electronic passport, enable agencies to take automated actions based on taxable actions, tax-enforcement actions, tax refund information, etc., and to correlate actions across agencies.

In some examples, data objects resident on one ecosystem (e.g., ecosystem 1) may be accessible by devices and/or software engines of another ecosystem (e.g., ecosystem 2, ecosystem N). If a requested data object resides outside the immediate ecosystem (the ecosystem within which the requestor intelligent data engine is registered), or if the data object requested is otherwise unknown to an ecosystem's data registrar, the request for the data object may be routed to an intelligent data engine registrar/registrar service (e.g., intelligent data engine registrar 122 and/or intelligent data engine registrar service 120) to broker the data request with another data registrar of a different ecosystem (e.g., of ecosystem 2 and/or ecosystem N). The intelligent data engine registrar/registrar service (e.g., intelligent data engine registrar service 120, 120a, and/or 120n) may maintain a registry of other ecosystems' data registrars, data objects (and locations of the data objects), data owners, and ecosystem location information. The intelligent data engine registrar may direct the data request to the relevant ecosystem's data registrar and/or data owners. If the data requested resides in another available ecosystem and is authorized by the data owner, a copy of the data object may be transmitted to the data requestor's device. It should further be understood that ecosystem data registrars are not required to register with an intelligent data engine registrar. This allows for private data registrars that are not globally discoverable to broker data transactions. The design also allows larger organizations to operate private intelligent data engine registrars enabling private enterprise data scaling.

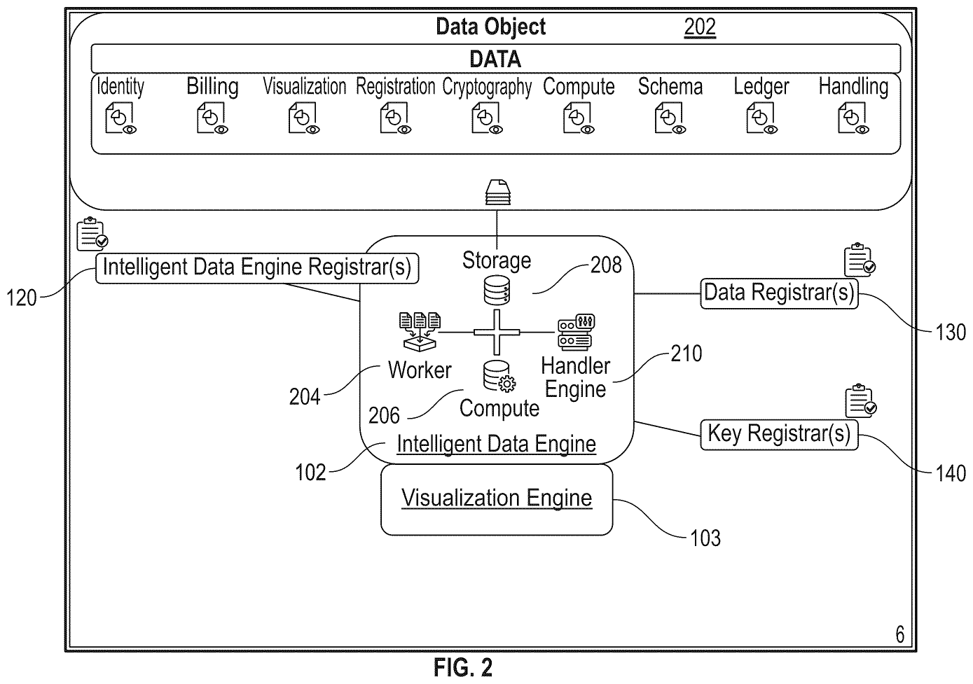

As noted above, the software engine(s) provided on device(s) 104 and/or 106 may be configured for edge processing of data objects. The intelligent data engine(s) 102 and/or 105 may include workers 204, compute resources 206, a storage mechanism 208, and a handler engine 210, for instance, as shown in FIG. 2. The workers may be computational entities that perform the assigned tasks. Workers may include a thread, a process, or even a separate machine in a distributed computing environment. Workers may handle incoming requests, process them, and send back the appropriate responses. Each worker may handle a request independently. Workers may receive tasks from a master node, a scheduler, or a load balancer that allocates tasks based on the workers' availability and capacity. Workers may communicate with each other or with a central coordinator to exchange data, status updates, or results. Workers may further utilize resources like CPU, memory, and storage to execute tasks. A worker may be a temporary computational entity that interacts with edge device software and hardware hosting the worker to perform assigned tasks, including providing, retrieving, and maintaining data objects. Workers may be activated and deactivated as needed to perform discovery, handling, packaging, unpackaging, and ingestion of data objects at the entry and exit points of edge devices.

The intelligent data engine(s) 102 and/or 105 may leverage workers 204 to perform multiple functions. Workers 204 may be configured to validate other intelligent data engine services. Workers 204 may be configured to transmit data object location information to the data registrar service (e.g., the data registrar service 130). Workers 204 may be configured to store unique data object identification and location information. Workers 204 may be configured to generate of cryptographic keys and/or store of cryptographic keys in a data object cryptography module. Workers 204 may be configured to transmit of cryptographic keys to the key registrar (e.g., key registrar 142) upon request. Workers 204 may be configured to communicate data requestor identity information to the key registrar listed in a registration module of a data object. Workers 204 may be configured to perform data decryption and updates using identity information obtained from data requestor. Workers 204 may be configured may be configured to provide data visualization schema and preferences to data requestor and data owner visualization engines.

Compute resources 206 may include any of the processing resources, environments, methodologies, and technologies that enable the execution of software applications and the processing of data. For instance, compute 206 may include algorithms for running software programs and executing instructions, virtual machines, containers, and so on. Storage mechanisms 208 may include databases, file systems, and so on. The handler engine 210 may be or include a logical software program or component. The handler engine 210 may include event handlers (e.g., functions triggered in response to certain events), request handlers (e.g., components that receive and respond to requests), message handlers (e.g., to receive, process, and route messages), and so on. The handler engine 210 may evaluate and respond to event handlers, request handlers, and message handlers. The handler engine 210 may enforce handling instructions, which may be or include directives defined by the data author (e.g., creator of a data object) for how the data object should be processed (e.g., accessed, manipulated, visualized) and may describe the actions that can be performed after processing. Continuing with the medical record example, the intelligent data engine may be configured to execute various instructions included in the medical record, for instance, calling an MRI image processing algorithm based on instructions in the data object. The visualization engine may be configured to generate a display (e.g., of MRI image data) based on instructions included in the data object.

FIG. 2 provides a more detailed illustration of an exemplary data object 202 stored at an intelligent data engine 102 connected to various registrar services including an intelligent data engine registrar service 120, data registrar service 130, and key registrar service 140. As shown, the data object includes data and a variety of processing instruction modules, including an identity module, a billing module, a visualization module, a registration module, a cryptography module, a compute module, a schema module, a ledger module, and a handling module. The respective modules may include instructions for how the data should be processed (e.g., visualized, manipulated, handled, etc.) by an intelligent data engine and/or visualization engine, as described in further detail throughout. The intelligent data engine 102 of FIG. 2 includes workers, compute resources, a storage mechanism that stores the data object, and a handler engine, and the intelligent data engine is connected (e.g., via one or more wired or wireless communication protocols) to a variety of services and corresponding registrars provided by those services.

The descriptions of FIGS. 3-7 below illustrate how components of an exemplary (e.g., system 100) may interact to perform the systems and methods described herein. For instance, an exemplary system such as system 100 described above may be utilized to, for instance, create data objects, register the data objects with data registrar services and key registrar services, broker requests for access to data objects, selectively decrypt, visualize, and update data objects, and synchronize updates across copies of the data objects distributed across edge devices connected to the system, among other tasks. For instance, the data objects described herein may, in some embodiments, be created based on a data template obtained from a data registrar service. The data template may be requested by an intelligent data engine at an edge device (e.g., owner device), and visualized and modified by a user (e.g., enriched, etc.) to create a data object. The data template may be a data object that includes some but not all of the modules (e.g., processing instructions) included in a data object.

As an example, a data template may be a virtual passport that a traveler may download that is pre-configured with various processing/handling instructions. For instance, the template may include processing instructions that instruct an intelligent data engine to transmit an alert to a data registrar service (or other service) when a device hosting the intelligent data engine crosses a border of interest. However, the data template may not come pre-configured with a data owner identity, registration information, cryptography information, and so on. These modules of the data object may be configured after a data template is downloaded from the data registrar. Accordingly, once a user has downloaded the template, for instance, the virtual passport, the user may input their identity information into the virtual passport, register the virtual passport with a key registrar and encrypt the virtual passport or a portion thereof, and register the virtual passport with the data registrar from which it was obtained (and/or other data registrar services) so that it can be located and requested by other edge devices. An exemplary process for creating a data object based on a data template is described below with reference to FIG. 3.

FIG. 3 illustrates an exemplary process 300 for creating a data object, in accordance with some embodiments. Process 300 is performed, for example, by a computing system implementing a software platform. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 302, an owner or organizational device downloads an intelligent data engine (e.g., intelligent data engine 102 of FIG. 1A) from an application store or provided by a centrally managed service. The intelligent data engine may be a software engine that enables a user device to interact with the ecosystem to create, register, and access data objects. For instance, using a mobile device, a user may access the Apple App Store®, Google Play™ Store, and so on to download an intelligent data engine. In some embodiments, the intelligent data engine may be obtained directly from a service provider, for instance, via a download link provided on a public or private website. As an example, similar to the virtual passport example described above, process 300 may be performed by the Federal Emergence Management Agency (FEMA) during a natural disaster response to allow individuals to create and register data objects with their own registration service to track the location of people in shelters, track unique medical needs of those people, process requests for financial assistance, and/or dispatch first responders. Accordingly, FEMA may provide a link to download an intelligent data engine on their public website or in an application store that allows users to download an intelligent data engine authorized to interact with a FEMA ecosystem.

At block 304, after downloading the intelligent data engine, the owner or organizations device transmits a validation request of the intelligent data engine to an intelligent data engine registrar service. For instance, the intelligent data engine may automatically initiate a validation request upon the initial launch of the engine. The validation request may include, for instance, the intelligent data engine version, license key, user account information, and/or device identifiers associated with the owner device that downloaded the intelligent data engine. The information included in the validation request may be encrypted using one or more common encryption protocols and transmitted to the intelligent data engine registrar service using any wired or wireless communication protocols (e.g., Wi-Fi, Bluetooth, Ethernet, etc.).

At block 306, an intelligent data engine registrar service validates the intelligent data engine. The intelligent data engine registrar service may be a web service that is configured to ensure that only authorized intelligent data engines are provided access to a respective ecosystem. The intelligent data engine registrar service may receive and decrypt the data to validate the engine and/or user's credentials. The intelligent data engine registrar service may check the received and decrypted data against a database of valid licenses, subscriptions, registered users, authorized devices, and so on to determine whether the intelligent data engine is authenticated.

At block 308, upon authenticating the intelligent data engine, the intelligent data engine registrar service stores location information (e.g., a device identifier associated with the owner device and/or computing network location information for the data object including a location of an edge device storing the data object in the computing network), generates a unique identifier associated with the validated intelligent data engine and transmits the unique identifier to the owner device. At block 310, the owner device stores the unique identifier associated with the intelligent data engine.

At block 312, after completing the authentication process, the owner device may download a data template from an organization associated with the data registrar service. For instance, the owner device may access a public website of a provider of the data template and click, tap, or otherwise select a link to request to download the data template from the public website. The data template may include one or more modifiable or user interactive fields that enable the owner device to add, delete, and/or change information stored in the data template, for instance, based on inputs received from a user of the owner device, as described further throughout. At block 314, the data registrar service transmits the data template to the owner device using any wired or wireless communication protocol (e.g., Wi-Fi, Bluetooth, Ethernet, etc.). At block 316, the owner device stores the data template within its intelligent data engine.

At block 318, the owner device receives user inputs through a visualization engine and modifies (e.g., add, delete, modify) data in the data template based on user inputs to create a data object. For example, after downloading a data template to the owner device, the visualization engine may cause a user interface to be displayed at the owner device. The visualization engine may prompt a user to provide additional data to the data template. Returning to the FEMA example described above, a user may enter their name, address, or other information into text fields, using drop-down menus, etc. The user may also add their location to the data template, or the owner device may automatically add location data (e.g., using GPS coordinates obtained from a GPS device on the owner device) to the data template. The user may upload their medical records with instructions to allow access to specified portions of the records to various personnel.

The data object may be formed of a variety of modules, each comprising specific types of data and/or processing instructions. The data object may include an identity module, a billing module, a visualization module, a registration module, a cryptography module, a compute module, a schema module, a ledger module, a handling module, and a data module. The identity module may include unique identifiers for the data object, unique identifiers defining an owner of the data, an intelligent data engine associated with the owner of the data, or the device at which the owner's intelligent data engine is installed. The registration module may include unique identifiers associated with the data object that are generated upon registration of the data object with various web services, such as the data registrar services and key registrar services described herein. The visualization module may include a variety of instructions for visualizing the data in a data object based on the type of data, the format of the data, etc. The cryptography module may include cryptographic information that can be used to obtain keys from a key registrar needed to decrypt portions of data in the data object. The billing module may include instructions to request or make payment for processing the data in the data object, thus enabling the data objects to self-enforce economic compensation. The compute module may include instructions to call compute resources (e.g., workers, algorithms, external tools such artificial intelligence algorithms, etc.) or instructions to run algorithms embedded in the data for purposes such as enriching the data, validating the data, providing additional features, or providing additional handling instructions. The handling module may include instructions for how the data object should be handled, for instance, that copies of the data object should be deleted after a predefined time period. The schema module may include information regarding how the data is organized in the data object. The ledger module may enable all changes to the data object to be recorded within the data object's ledger. Finally, the data module may include any type of data. For instance, the data module may include unstructured data such as text data or multimedia data, structured data such as tabular or relational data, or semi-structured data such as XML or JSON data. The data module may include survey data, experimental data, archival data, public data, personal identifying information, financial data, medical data, location data, and so on to include any type of data. Thus, the data object may include, but is not limited to, a collection of discrete or continuous values that describe the quantities, qualities, facts, statistics, and/or other basic units of meaning, simple sequences of symbols that may be further interpreted formally, software programs, algorithms, machine learning models, etc. Other modules may be added to the data object by the data requestors, authors, or owners, if they are authorized (e.g., if the data object is configured to enable addition of modules).

As an example, data object may include an electronic passport. Traditional (e.g., paper) passports are limited in that passport actions (e.g., border crossings, etc.) may not be automatically shared between government agencies. An electronic passport in the form of a data object could enable agencies to take automated actions based on passport actions and to correlate actions across agencies. Accordingly, the State Department, for instance, could open a data registrar for international travel and provide access to an international travel data template through the data registrar. A user may download a data template from the data registrar and input their personal information into the template to create a data object. The data object may then be registered to the State Department's data registrar service, which may store identity and location information of the data object in a data registry as part of the registration process, which may be accessible in order to locate the data object (e.g., identify the device storing the data object and owner of the data object) upon request for access to a copy of the data object by a requestor device. The data object may be modified by the State Department to include handling instructions provided to the State Department by one or more different government agencies or departments (e.g., Customs and Border Protection (CBP), Immigration and Customs Enforcement (ICE), etc.) requesting the record be registered in a data registrar owned by the other government agencies or departments if some condition is satisfied, for instance, if the passport is used to enter one or more defined countries of interest. Accordingly, when the data owner uses the data object to cross a border into a country of interest, the data object may automatically be registered with data registrar services owned by CBP and/or ICE such that CBP and ICE are notified of, for instance, the identity, location, travel history, etc. of the owner of the data object.

As another example, similar to the electronic passport concept, a municipal, state, or national government entity may create a data registrar service to which each of its citizens, registered corporations, or other authorized entities can register a data object, similar to a form of electronic identification, but which can be used to automatically update all state records associated with the individual or organization and communicate those updates to other entities. For example, a user with a registered data object may include processing instructions that instruct the data registrar service to register their data object with a new utility provider, new voting location, public transportation service, library, and so on when the individual moves to a new residence. Such a data object may be particularly useful with the rise of smart cities, which may leverage intelligent infrastructure and data to address challenges associated with urbanization and enhance the quality of life in modern cities.

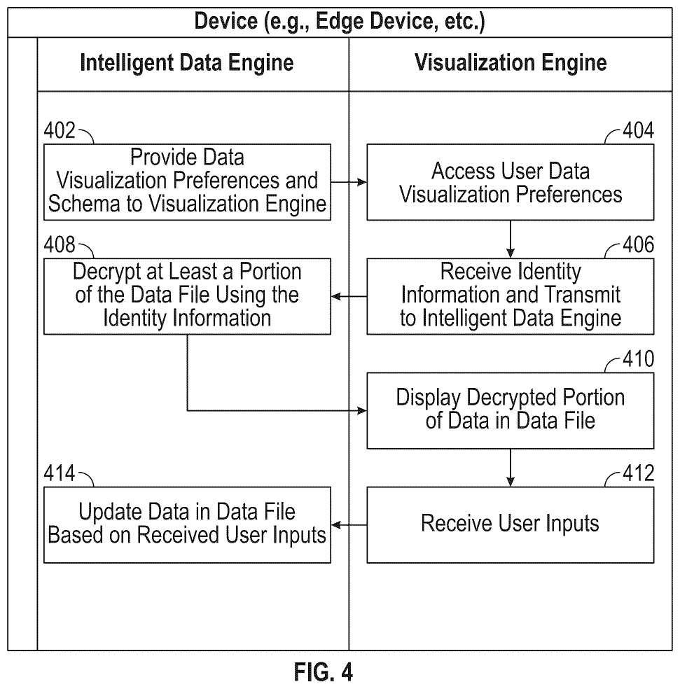

The way the data template is displayed to the user may depend on both visualization instructions included in a visualization module of the data template and/or visualization preferences configured by the user at a visualization engine. The visualization engine may be a mobile or web application separate from the intelligent data engine and may be downloaded and authenticated in the same manner as the intelligent data engine described above. In some embodiments, the visualization engine may be a component of the intelligent data engine and may be authenticated along with the intelligent data engine. A more detailed description of the manner in which the visualization engine causes user interfaces to be displayed for the purpose of modifying a data object is provided below with reference to FIG. 4.

FIG. 4 illustrates an exemplary process 400 for visualizing and modifying a data object according to some embodiments. Process 400 is performed, for example, by a computing system implementing a software platform. In process 400, some blocks are, optionally, combined, the order of some blocks is, optionally, changed, and some blocks are, optionally, omitted. In some examples, additional steps may be performed in combination with the process 400. Accordingly, the operations as illustrated (and described in greater detail below) are exemplary by nature and, as such, should not be viewed as limiting.

At block 402, an intelligent data engine provides data visualization preferences and data schema to a visualization engine based on data visualization preferences and schema information included in a data object. Both the intelligent data engine and visualization engine may be software engines installed on an electronic device. In some embodiments, the visualization engine is separate from the intelligent data engine. In some embodiments, the visualization engine is a component of the intelligent data engine. The visualization preferences may form a portion of the processing instructions (e.g., a visualization module) described above and may be based on the type of data included in the data object and/or may be defined by the data owner and/or the web services administrator. The visualization preferences may provide a wide variety of instructions for visualizing the data in a data object. For instance, visualization preferences may include instructions for selecting more simplistic or more complex visualizations (e.g., bar charts vs. 3D plots) or for selecting an appropriate chart type based on the type of data (e.g., using line charts for visualizing time-series data and heat maps for correlation matrices). The visualization preferences may include instructions for proper color usage (e.g., to identify groups of data points); for properly labeling data and annotating charts; for displaying static, dynamic, and/or interactive visualizations; for visualizing data in a manner most accessible to those with disabilities (e.g., choosing a proper color scheme to ensure that the visualization is useful for users with color-blindness); for tailoring visualizations to one or more predefined audiences (e.g., displaying different visualizations based on whether the individual accessing the data object is a doctor or a patient); and so on. The data schema may form a portion of the processing instructions (e.g., a schema module) described above and may instruct the visualization engine regarding how the data to be visualized is organized in the data object. The schema may impact the way the data can be visualized within the boundaries of the visualization preferences. For instance, well-organized, structured data can be visualized more effectively relative to unstructured data.

At block 404, the visualization engine accesses user data visualization preferences. The user data visualization preferences are distinct from the data visualization preferences and are specific to the visualization engine and/or device on which the data is being visualized. In some embodiments, the user visualization instructions may override contradictory or overlapping visualization instructions included in the data visualization instructions. For example, if a user is color blind, the user may configure a preferred color scheme using the data visualization engine, which may replace or supplement a color scheme defined in the data visualization instructions. As another example, if a user is blind, the user may configure the visualization engine to provide an audio output along with the visualization. In some embodiments, the data visualization preferences may instead override contradictory or overlapping user visualization preferences.

At block 406, the visualization engine receives identity information from a user (e.g., via a user input) and transmits the identity information to the intelligent data engine. In some embodiments, the user's identity information may be used by the intelligent data engine to decrypt/unlock a portion of the data in the data object that the user is authorized to interact with. The intelligent data engine may also receive cryptographic keys (e.g., public/private keys) from a key registrar service based on cryptography information included in the data object and use the cryptographic keys along with the identity information to determine which portion of the data the user is allowed access to, and decrypt that portion of the data. Accordingly, at block 408, the intelligent data engine decrypts at least a portion of the data in the data object using the identity information.

At block 410, the visualization engine generates a visualization and displays the visualization of the decrypted portion of the data in the data object. As described above, the display may depend on the data to be displayed, the intelligent data visualization preferences, data schema, user visualization preferences, and/or other processing instructions included in the data object.

At block 412, the visualization engine may receive user interactions with the data via a user interface. For instance, the visualization engine could present as a web browser or other interactive graphical user interface configured to receive user inputs (e.g., text inputs, selections such as check-the-box or drop-down menu selections, file uploads, and/or any other manner of adding to, deleting, modifying, or otherwise interacting with a displayed data visualization).

As an example of the resulting visualizations and subsequent user interactions described with respect to process 400 described above, a doctor may receive a data object that includes a patient's medical records, however, depending on the processing instructions and physician's identity, the cryptography information included in the data object, and other processing instructions included in the data object, the physician may be granted access to a visualization of a different portion of data than a different user, or even a different doctor. As an example, a dentist may be granted access to the full scope of a patient's dental x-ray records. The intelligent data engine may decrypt all dental x-rays and the visualization engine may generate visualizations of the x-rays. The visualizations may be interactive, allowing the dentist to annotate the images, delete images, and add new x-ray images to copies of the data object. In contrast, a patient's primary care physician may be granted access to non-interactive visualizations of the dental x-rays and may not have any ability to add, delete, or modify any of the x-ray images. Further, a psychiatrist may have no need for dental records, and so the cryptography information included in the data object may instruct the key registrar to grant a psychiatrist cryptographic keys that decrypt a different portion of the data than the dentist, providing no access to the dental x-ray images.

Once a data object is created, it may be registered with the various web services of the ecosystem to enable other users to locate and access the data object. For example, the original data object may be stored at the intelligent data engine of the owner device. This location may be registered by the data registrar service so that when requestor A contacts the data registrar service to request a copy of the data object owned by individual B, the data registrar can forward the request to the owner B's device without compromising the owner B's privacy, location, etc. The data registrar service acts as a domain name service for data objects, brokering access to data objects, synchronizing copies of data objects across the ecosystem as changes are made to one of the copies, etc. The data object can also be registered with a key registrar service that acts as a cryptographic key broker to provide allowed keys to authorized requestors. They keys may be requestor-specific, providing requestor C different access privileges than requestor D. The keys may be configured to enable access to any portion of the data object. For instance, a key may unlock anything from a field of the data object (e.g., a single data element or attribute such as a text box on a form that allows a user to enter their name) to an entire database stored within the data object. In other words, keys may grant access at any level of the data storage hierarchy within the data object. A more detailed description of a process for registering the data objects is provided below.

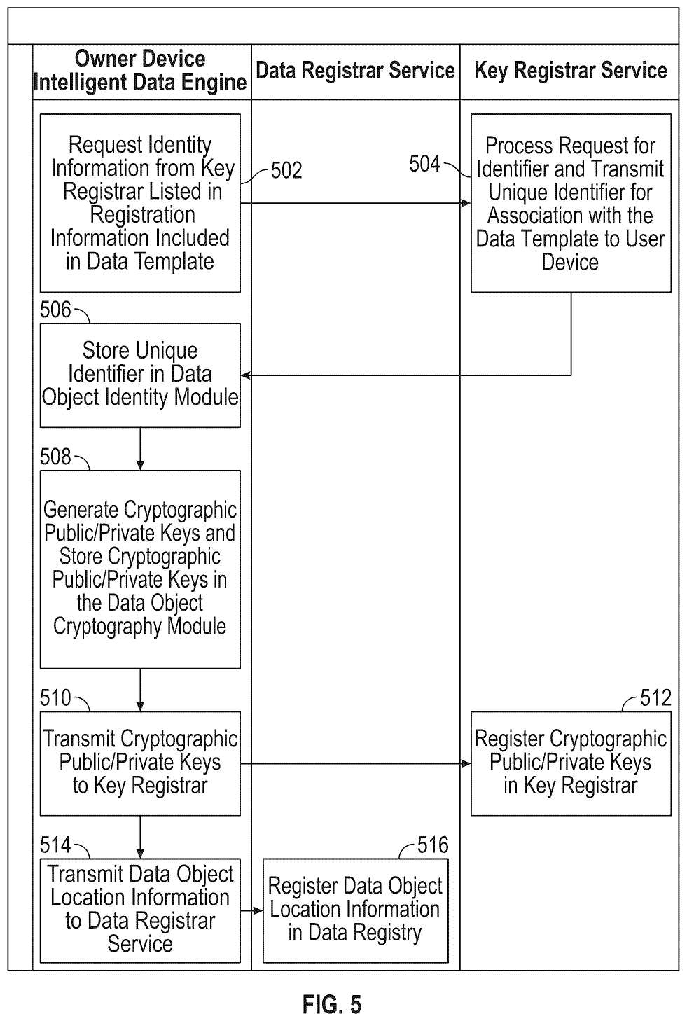

FIG. 5 illustrates a process 500 for registering a data object with a data registrar service and key registrar service, according to some embodiments. Process 500 is performed, for example, by a computing system implementing a software platform. In process 500, some blocks are, optionally, combined, the order of some blocks is, optionally, changed, and some blocks are, optionally, omitted. In some examples, additional steps may be performed in combination with the process 500. Accordingly, the operations as illustrated (and described in greater detail below) are exemplary by nature and, as such, should not be viewed as limiting.

At block 502, the owner device intelligent data engine may transmit to a key registrar service a request for an identifier to associate with/assign to a data object. The key registrar service may be a web service listed in a registration module of the data template received from the data registrar service and stored in a storage component of an intelligent data engine, for instance as described above with reference to FIGS. 1 and 2. The request for the identifier may include identifying information associated with the data owner (e.g., the user of the requesting device) or identifying information associated with the owner device (e.g., a MAC address, device ID, Universally Unique Identifier (UUID), etc.).

At block 504, the key registrar service processes the request for the identifier received from the owner device and transmits a unique identifier for association with the data object to the owner device. The unique identifier may be a unique token, a checksum, a hash value, a Globally Unique Identifier, or any other unique identifier for identifying a data object.

At block 506, after receiving the unique identifier, the intelligent data engine stores the identifier in an identity module of the data object. At block 508, after storing the identifier, the intelligent data engine generates one or more cryptographic public and/or private keys associated with the data object and unique identifier and stores the keys in a cryptography module of the data object. In some embodiments, the key registrar service may generate the one or more cryptographic public and/or private keys associated with the data object and unique identifier and store them in the key registrar and/or transmit the cryptographic public and/or private keys to the intelligent data engine.

At block 510, the owner device intelligent data engine transmits the one or more cryptographic public and/or private keys associated with the data object and unique identifier to the key registrar service. At block 512, the key registrar service registers the one or more cryptographic public and/or private keys associated with the data object and unique identifier in a key registrar. The key registrar may be any secure storage mechanism, such as a secure data enclave, a file system, or a hardware device such as a smart card, USB, or other storage device.

At block 514, the owner device transmits location information for the data object to the data registrar service. The location information may include a unique identifier associated with a device (e.g., device fingerprint, MAC address, etc.) and/or intelligent data engine (e.g., unique Application ID or fingerprint) at which the data object is stored. The location information may include computing network location information for the data object, including a location of an edge device storing the data object in the computing network. The location information may enable the data registrar service to locate the data object when a requestor device transmits, to the data registrar service, a request for access to the data object.

At block 516, the data registrar service registers the data object location in a data registry. The data object may be stored in a lookup table or other data structure of the data registrar that associates respective data objects with a location. In other words, the data registrar may store an indication that a data object is stored at Device A, which is operating intelligent data Engine B. Accordingly, if a requestor device transmits, to the data registrar service, a request for access to the data object, the data registrar service can route that request to Device A and/or intelligent data Engine B. A unique data object may be registered with more than one data registrar service. For instance, a passport data object may be registered with a data registrar service provided by the State Department, Customs and Border Protection, Immigration and Customs Enforcement, etc., a medical record data object may be registered with a registrar service provided by an individual's primary hospital network and a registrar provided by their insurance network, and so on.

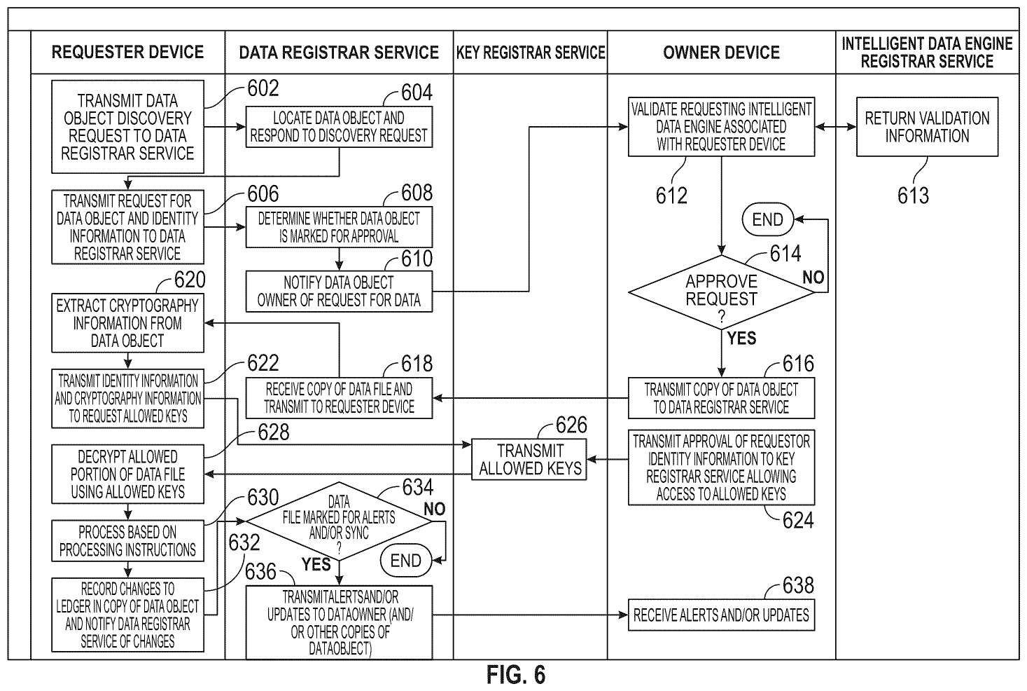

Once the data object has been registered with a data registrar service, it can be located by other devices. For instance, a device can transmit requests for access to the data object to the data registrar service, and the data registrar service can broker access to copies of the data object by communicating the request to the owner device. FIG. 6 illustrates an exemplary process 600 for brokering access to data objects via a data registrar service. Process 600 is performed, for example, by a computing system implementing a software platform. In process 600, some blocks are, optionally, combined, the order of some blocks is, optionally, changed, and some blocks are, optionally, omitted. In some examples, additional steps may be performed in combination with the process 600. Accordingly, the operations as illustrated (and described in greater detail below) are exemplary by nature and, as such, should not be viewed as limiting.

At block 602, a requestor device transmits a discovery request for a data object to a data registrar service. The discovery request may be transmitted according to any appropriate wired or wireless communication protocol and may include an identifier associated with the subject data object of the discovery request (e.g., a public key, a name, etc.). For instance, in some examples, the data object may be a medical record, and a requestor device may be associated with a university conducting a study (e.g., clinical trials or other research), a doctor's office, or other medical facility. The requestor device may transmit a request for the data object to the data registrar service operated by the medical facility, university, etc. While the aforementioned example is described with reference to a user operating the requestor device, it should be understood that the requestor device may additionally or alternatively be configured to automatically transmit such a request without receiving a user input (e.g., upon satisfaction of some condition, such as a patient making an appointment, or upon receiving a list of participants for a study, etc.).

At block 604, the data registrar service processes and responds to the discovery request. The data registrar service may determine whether the requested data object is registered with the data registrar service (e.g., by querying a data registry for a unique identifier included in the discovery request), and if it is, then determine where that data object is located (e.g., by identifying the device and/or intelligent data engine at which the data object is stored). Upon locating the data object, the data registrar service may transmit a response indicating that the data object has been discovered to the requestor device. Continuing with the medical record example described with respect to block 402, the data registrar service may determine whether a data registry includes a medical record for patient Jane Doe. If the data registrar service determines that Jane Doe has registered her medical records with the medical facility's data registrar service, it may transmit a response to the requestor device indicating that the data object has been discovered in the data registry.

At block 606, the requestor device transmits a request for access to the discovered data object. The request may include identity information to enable the owner device to validate the requestor device intelligent data engine. The identity information may include a unique identifier associated with an intelligent data engine of the requestor device (e.g., unique Application ID or fingerprint), a unique identifier associated with the requestor device itself (e.g., MAC address, device fingerprint, etc.), and/or an identifier (e.g., name, email, etc.) of a user associated with the requestor device. This incorporates a zero-trust capability into the exchange process, enabling the data owner device to validate the requestor.

At block 608, the data registrar service determines whether the requested data object is marked for approval. For instance, the data object owner may indicate to the data registrar service that requests for access are being accepted and/or that data owner approval is required before distributing a copy to the requestor. In some embodiments, the data registrar service may query the data object via the intelligent data engine at the owner device to determine whether the data object is marked for approval. For instance, the data object may include processing instructions that indicate requests for access are being accepted. In some embodiments, the processing instructions may indicate that requests for access are being accepted only from specified requestor devices, individuals, and/or organizations.

At block 610, in accordance with determining that the requested data object is marked for approval, the data registrar service transmits the request for access to the data object to an owner device, and the data owner (e.g., a user of the owner device) is notified of the request for access. The notification may include visual, auditory, or haptic elements. For instance, the notification may be displayed on an interactive display of the owner device (e.g., by the visualization engine described with reference to FIG. 1A). Additionally, or alternatively, the notification may be an auditory notification to which the user can respond verbally.

At block 612, the intelligent data engine at the owner device validates the requesting intelligent data engine and/or the requestor. The intelligent data engine may validate the requesting intelligent data engine and requestor based on an identifier associated with one or both of the requestor and requesting intelligent data engine. The identifier may include a unique identifier associated with the requesting intelligent data engine, a name, email, address, phone number, and so on, for the requester that enables the intelligent data engine at the owner to validate the requestor and requesting intelligent data engine. The intelligent data engine at the owner device may transmit an identifier associated with one or both of the requestor and requesting intelligent data engine to an intelligent data engine registrar service, and the intelligent data engine registrar service may return a validation of the requesting intelligent data engine and/or the requestor at block 613.

At block 614, the intelligent data engine at the owner device determines whether to approve or deny the request for access to the data object. In some embodiments, the intelligent data engine at the owner device may prompt a user (e.g., the data owner) to either approve or deny the request. In some embodiments, the intelligent data engine at the owner device may autonomously determine whether to approve or deny the request according to processing instructions included in the data object. For instance, the data object may include processing instructions that instruct the intelligent data engine to approve requests from one or more requestors (e.g., based on unique identifiers associated with the requestors) and to deny requests from other requestors.

At block 616, if the request for access is approved, the owner device transmits a copy of the data object to the data registrar service. At block 618, the data registrar service receives the copy of the data object and transmits the received copy to the intelligent data engine at the requestor device. Accordingly, the data registrar service may act as a broker transferring requests for data and the data itself between a requestor and owner device. By doing so, the data registrar service may also act as a privacy preservation mechanism that withholds identity or location information from one or more of the respective endpoint devices (e.g., the requestor device and owner device). It should be understood that in some embodiments, the data registrar service may not act as a data broker (e.g., an intermediary) between a requestor device and owner device. For instance, in some embodiments, a requestor device may transmit requests directly to an owner device, and the owner device may transmit copies of a data object directly to the requestor device.

At block 620, after receiving a copy of the data object, the requestor device extracts cryptography information from the copy of the data object. The cryptography information may include any combination of public and/or private cryptographic keys, a unique identifier associated with the data owner, a unique identifier associated with the owner device, and/or a unique identifier associated with the intelligent data engine at the owner device.

At block 622, the requestor device transmits an identifier and the cryptography information extracted from the copy of the data object to a key registrar service. The identifier may be a unique identifier associated with the intelligent data engine at the requestor device, the requestor device itself, and/or a user of the requestor device. The identifier may include a unique identifier associated with the requesting intelligent data engine, a name, email, address, phone number, and so on, that were validated by the owner device intelligent data engine at step 412.

At block 624, the owner device transmits an approval of the requestor identifier to the key registrar instructing the key registrar to provide the requestor device access to one or more allowed cryptographic keys. At block 626, the key registrar service transmits the allowed keys to the requestor device intelligent data engine. The allowed keys may be a subset of all cryptographic keys associated with the data object. For instance, certain requestors may be granted access to different keys than other requestors. Returning to the medical record example described above, the requesting university conducting a study may be granted a subset of keys that allow for decryption of a portion of the data owner's medical records that are pertinent to the given study that the data owner has granted the requestor access to. Accordingly, while a copy of the entire data object may be transmitted to the requestor, the requestor may only be able to decrypt a portion of the information in the copy of the data object. In contrast, if the requestor is a patient's primary care provider, the requestor may be granted access to all keys associated with the medical record.

While described with reference to a single owner device, it should be understood that a data object may include data owned by multiple parties. For instance, for a homogeneous data object (one with a single owner), a single data author or data owner maintains complete control over all elements of a data object. However, a heterogeneous data object includes portions owned by different respective authors/owners. Heterogeneous data objects may require the data registrar and key registrar to have knowledge of the various owners of the individual portions (e.g., modules of the data object) in order to broker data exchange using identification and credentialing for required access controls (e.g., cryptographic keys, etc.).

At block 628, the requestor device intelligent data engine decrypts at least a portion of the copy of the data object using the allowed keys provided by the key registrar. At block 630, the requestor device intelligent data engine processes the decrypted portion of the data in the data object based on processing instructions included in the data object. In some embodiments, the processing instructions may be included in the portion of the data decrypted at block 628. In some embodiments, the processing instructions may be stored in an unencrypted portion of the data object. As described above, the data object may be formed of a variety of modules, each comprising specific types of data and/or processing instructions such as an identity module, a billing module, a visualization module, a registration module, a cryptography module, a compute module, a schema module, a ledger module, a handling module, and a data module.

In some embodiments, the processing instructions may include instructions for calling a compute resource, such as a specific computer program, for processing the data in the data object. The processing instructions may include instructions for prompting a device for payment for processing the data in the data object. The payment instructions may depend on, for instance, the size of the data object, the compute resource required for processing the data object, or a user-configured price for processing the data object. The processing instructions may include instructions for running external algorithms or web services such as machine learning or artificial intelligence tools to augment the data object. In some embodiments, the processing instructions include instructions for determining whether a condition included in the processing instructions has been satisfied and performing an action based on the condition being satisfied. For instance, the condition may include any of a device entering a certain geographic location, a device receiving a request to access the data, or a step of a plurality of steps associated with processing the data being completed. The action may include any of generating an alert, performing the next step of the plurality of processing steps, or displaying an indication of the condition being satisfied.

Continuing the medical records example described above, for instance, a university conducting a study based on medical image data may receive a medical record data object. The university may be granted access to keys that decrypt certain medical image data and records associated with the image data in the data object. Prior to decrypting the data, the intelligent data engine of the university device may prompt the university for payment to allow the data to be decrypted and processed based on instructions in the billing module of the data object. This may enable the data owner to be compensated for their participation in the study. Once decrypted, required computing resources may be called to process the data in the data object. For example, if the image data is x-ray or MRI data, a computer program for visualizing and/or analyzing such image data may be called to process the data. Visualizing and/or analyzing a portion of the image data may be a condition that, once completed, causes the university's intelligent data engine to take an action, such as alerting the data owner intelligent data engine or visualizing and/or analyzing the next portion of the image data.

The processing instructions may further include any of: instructions for visualizing the data in the data object, instructions for recording updates to the data in the data object to a ledger included in the data object, a temporal limit for accessing the data in the data object, instructions for processing the data in the copy of the data object based on a format of the data in the data object, instructions prohibiting transmission of the data object to a third device, and instructions for processing the data according to a predefined sequence of processing steps.

In some embodiments, processing the decrypted portion of the data in the copy of the data object includes any of adding data to the data object, deleting data from the data object, and modifying the data included in the data object. In some embodiments, processing the decrypted portion of the data in the copy of the data object comprises any of adding processing instructions to the copy of the data object, deleting processing instructions from the copy of the data object, and modifying processing instructions included in the copy of the data object. In some examples, requestor device may edit existing aspects of the data object as authorized by the owner. In such cases, the data owner (e.g., the owner device in FIG. 6) may maintain homogeneous ownership of the data object. In some examples, the requesting entities may add new elements (e.g., new modules, processing instructions, etc.) to the data object that attach new conditions, in which case the requestor becomes an author of such new elements, enabling creation and registration of new data objects with heterogeneous ownership. This process of anticipated and prepared controls removes typical manual transactional access, imposes consistency, and reduces the data exploitation risk common to human interaction and decision.

In some embodiments, processing the decrypted portion of the data in the copy of the data object includes determining, based on the processing instructions in the copy of the data object, at least one required compute resource for processing the data in the copy of the data object; and calling at least one required compute resource to process the data. In some embodiments, processing the decrypted portion of the data included determining a cost associated with processing the data based on the processing instructions in the copy of the data object; prompting a device for a payment based on the billing instructions; and in accordance with receiving the payment, transmitting the payment to a different device.

In some embodiments, processing the decrypted portion of the data in the copy of the data object further includes determining that a condition included in the processing instructions has been satisfied; and in accordance with determining that the condition has been satisfied, performing an action. In some embodiments, the condition includes any of the second device entering a certain geographic location; a temporal limit for accessing the copy of the data object by the second device being reached; the second device receiving a request to access the data; or a step of a plurality of steps associated with processing at the second device the data being completed. In some embodiments, the action includes any of: generating an alert; transmitting the copy of the data object to a different device; deleting the copy of the data object; proceeding to a subsequent step of the plurality of steps for processing the data; adding data to the copy of the data object; deleting data from the copy of the data object; managing the lifecycle of the data object; and modifying data in the copy of the data object.

At block 632, the requestor device intelligent data engine records changes to the data based on the processing at step 630 to a ledger included in the copy of the data object and transmits the recorded changes to the data registrar service. At block 634, the data registrar service determines whether the data object is marked (e.g., includes instructions) for one or both of alerts and/or synchronization based on changes to the copy of the data object. If the data object is not marked for alerts or synchronization, the process 600 may end at block 634.

At block 636, if the data object is marked for one or both of alerts and/or synchronization, the data registrar service transmits one or more alerts to the owner device intelligent data engine and/or transmits the updates recorded in the ledger of the copy of the data object to the owner device intelligent data engine. In some embodiments, the alerts and/or updates may be transmitted to all devices that have a copy of the data object.

At block 638, the owner device intelligent data engine (and the intelligent data engine at any device that has a copy of the data object and receives the alerts/updates from the requestor device via the data registrar service) may output alerts received from the data registrar service (e.g., at a display or via a speaker of the owner device), and/or may update the data object based on the updates recorded in the ledger of the copy of the data object at the requestor device.

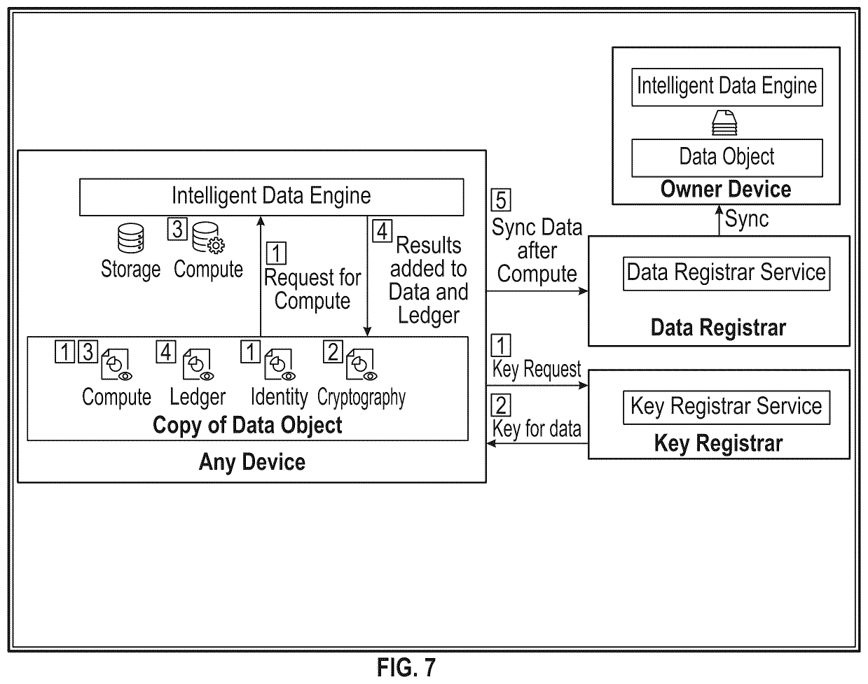

FIG. 7 illustrates an exemplary process 700 for processing a data object using a intelligent data engine. At step 1 (see elements labeled 1 in figure), an intelligent data engine at an edge device interprets compute instructions of a data object (e.g., from a compute module of the object) and requests key(s) from a key registrar service listed in the data object using identity information from the identity module of the data object. At step 2 (see elements labeled 2 in the figure), the key registrar service returns the requested key(s) to the edge device, and a the intelligent data engine decrypts the data based on the keys from the key registrar service for processing. At step 3 (see elements labeled 3 in the figure), the intelligent data engine compute resources run the compute instructions included in a compute module of the data object. The compute instructions may cause the intelligent data engine to process the data as described throughout (e.g., visualize the data, modify the data, delete data, run programs stored in the data object, etc.). At step 4 (see elements labeled 4 in the figure), the ledger module of the data object is updated (e.g., by the intelligent data engine) to reflect any changes to the data, store any results of the data processing, etc. to the ledger. At step 5 (see elements labeled 5 in the figure), the intelligent data engine performs a sync operation with data registrars listed in the data object (and/or with other edge devices that have copies of the data object).

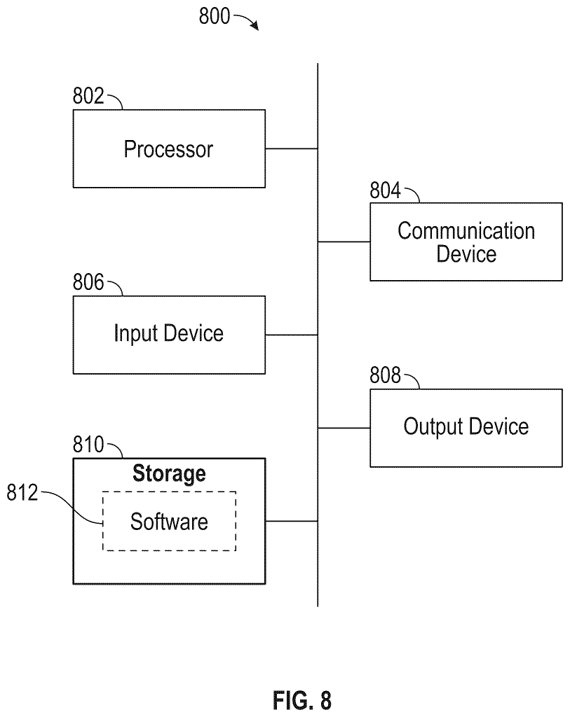

FIG. 8 depicts an exemplary computing device 800, in accordance with one or more examples of the disclosure. Device 800 can be a host computer connected to a network. Device 800 can be a client computer or a server. As shown in FIG. 8, device 800 can be any suitable type of microprocessor-based device, such as a personal computer, workstation, server, or handheld computing device (portable electronic device) such as a phone or tablet. The device can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides input, such as a touch screen, keyboard or keypad, mouse, or voice-recognition device. Output device 808 can be any suitable device that provides output, such as a touch screen, haptics device, or speaker.

Storage 810 can be any suitable device that provides storage, such as an electrical, magnetic, or optical memory, including a RAM, cache, hard drive, or removable storage disk. Communication device 804 can include any suitable device capable of transmitting and receiving signals over a network, such as a network interface chip or device. The components of the computer can be connected in any suitable manner, such as via a physical bus or wirelessly.

Software 812, which can be stored in storage 810 and executed by processor 802, can include, for example, the programming that embodies the functionality of the present disclosure (e.g., as embodied in the devices as described above).

Software 812 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by or in connection with an instruction execution system, apparatus, or device.

Software 812 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 800 can implement any operating system suitable for operating on the network. Software 812 can be written in any suitable programming language, such as C, C++, Java, or Python. In various embodiments, application software embodying the functionality of the present disclosure can be deployed in different configurations, such as in a client/server arrangement or through a web browser as a web-based application or web service, for example.

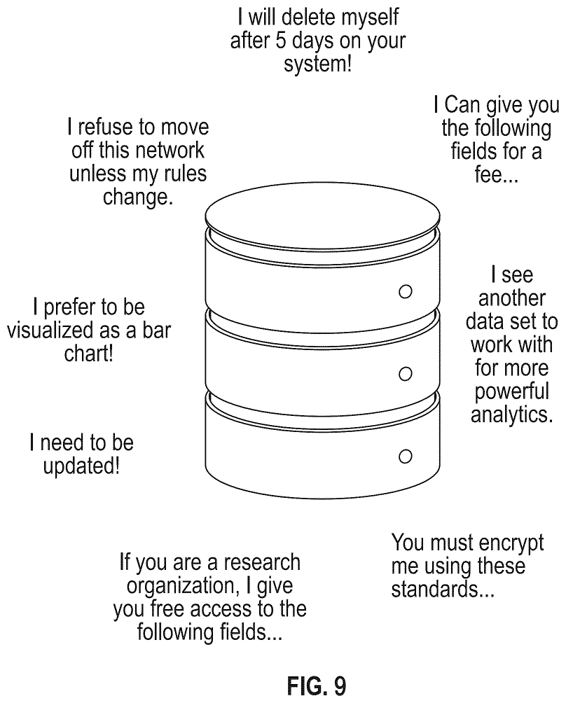

The data objects disclosed herein integrate “intelligence” in the form of different processing instructions that instruct devices, computing systems, applications, etc., how to process data within the data objects, such as security controls (e.g., cryptography instructions, visualization instructions, ledgering capabilities, etc.). This integrated intelligence enables data to be autonomous and independent, removing or reducing human intervention, and allowing data actions, interactions, and results to freely perform in a predictable and consistent manner while mitigating delays and missteps that occur through human interactions. FIG. 9 illustrates exemplary actions/behaviors that may be controlled by the “intelligent” data objects disclosed herein. For instance, as illustrated in FIG. 9, the data object may self-delete from a system after a predefined duration, the data object may provide access to portions of data for economic compensation, the data object may identify data that exists elsewhere within the system that can be combined with the data object for more powerful analytics, the data object can require certain encryption standards, the data object can indicate to a user when it needs to be updated, the data object can self-restrict its own transmission off a network or off a device, among other “intelligent” behaviors.

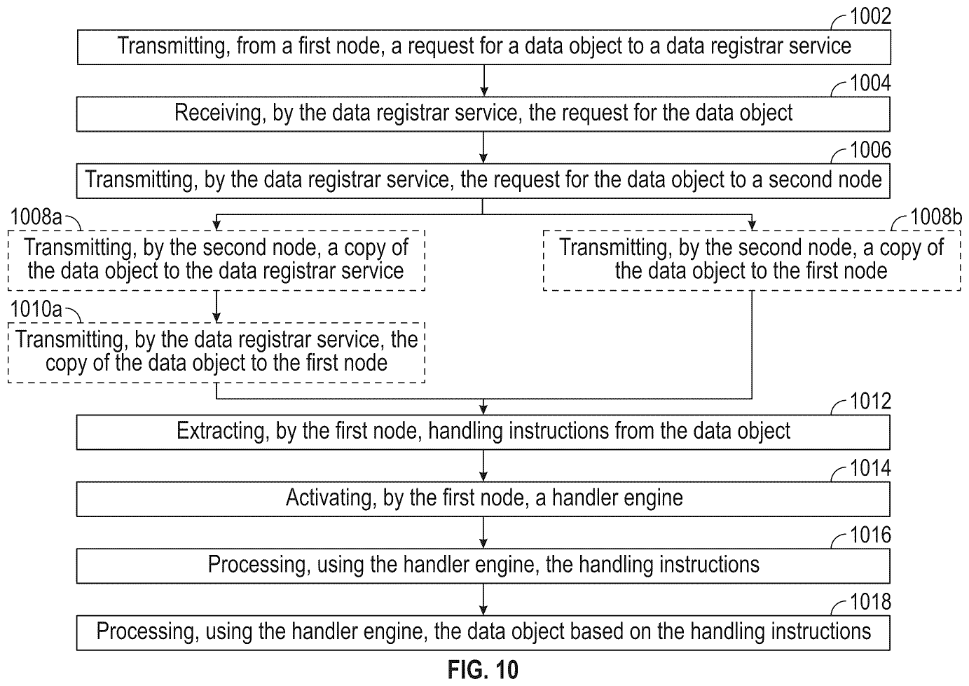

FIG. 10 illustrates a flowchart representing an exemplary process 1000 that may be implemented according to various examples disclosed herein, for instance using aspects of system 100 and/or data object 202. In some examples, one or more steps of the process 1000 may be included in the process 600 described above with reference to FIG. 6. At block 1002, process 1000 may include transmitting, from a first node (e.g., a computing device, such as an edge device), a request for a data object to a data registrar service (e.g., data registrar service 130). At block 1004, the process 1000 may include receiving, by the data registrar service, the request for the data object. The data registrar service may process the request according to any of the steps described herein, for instance, to identify another computing device (e.g., an owner device) that has the data object. At block 1006, the data registrar service may transmit the request for the data object to a second node (e.g., another computing device, such as another edge device). The other computing device may approve the request and, at block 1008a, may transmit a copy of the data object to the data registrar service. At block 1010a, the data registrar service may transmit the copy of the data object to the first node. Alternatively, at block 1008b, the second node may transmit the copy of the data object directly to the first node.

At block 1012, the first node may extract handling instructions from the data object. The handling instructions may be or include directives defined by the data author (e.g., creator of a data object) for how the data object should be processed (e.g., accessed, manipulated, visualized) and may describe the actions that can be performed after processing. At block 1014, the first node may activate a handler engine (e.g., handler engine 210) The handler engine may be or include a logical software program or component. The handler engine 210 may include manage event handlers (e.g., functions triggered in response to certain events), request handlers (e.g., components that receive and respond to requests), message handlers (e.g., to receive, process, and route messages), and so on. The handler engine may evaluate and respond to event handlers, request handlers, and message handlers. At block 1016, the handler engine may process the handling instructions. At block 1018, the handler engine may process the data object based on the handling instructions. The handler engine may delete the data object or data included therein, relocate the data object, execute one or more programs included in the data object or based on the data object's handling instructions, process data included in the data object, add to data included in the data object, etc.

Commercial cloud computing systems with automated native services configurations dominate the computing landscape, allowing data to be replicated and globally distributed at speeds that prevent full control and visibility for how that data is used, misused, and manipulated. Malicious actors threaten to misuse data, and rapidly spreading artificial intelligence capabilities heighten the risk posed when control over who can access data, how they access it, and under what circumstances they access it is lost. Unknowns surrounding data modification and disposition after data leaves a data author's possession create a lack of trust and confidence that data will not be misused or harmfully exploited.

The systems, methods, devices, and non-transitory computer readable storage media disclosed herein address the above concerns by creating a lightweight distributed architecture that enables a data author/owner to grant or restrict access to their created data object based on, for instance, a physical or logical location, an organization associated with the data requestor (e.g., individual or group requesting access to the data object), a data requestor's role in an organization, a time frame, or any other relevant characteristic applicable to securely sharing the data object. Security may be integrated through a zero-trust capability designed into the data object that allows the data itself to control how it is used and by whom, rather than relying on an application or program interface to drive the execution. Cryptographic controls provide a framework for allowing appropriate and timely use of data while forestalling misuse, abuse, or any use outside the wishes of the Data Owner. Altogether, this concept is a paradigm shift from today that fundamentally alters how data is distributed, secured, accessed, and utilized.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for sharing data between edge nodes of a data communication network comprising:
transmitting, by a first edge node, a request for a data object to a web service;
receiving, by the web service, the request for the data object;
determining, by the web service, based on the request, an identity of a second edge node that has the data object, wherein the identity of the second edge node is determined from a database that associates data objects with edge nodes;
transmitting, by the web service, a request to share the data object with the first edge node to the second edge node; and
transmitting, by the second edge node, a copy of the data object to the first edge node based on the request from the web service.

2. The method of claim 1, wherein the second edge node is an edge device associated with an owner of the data object.

3. The method of claim 2, wherein transmitting, by the second edge node, the copy of the data object to the first edge node based on the request comprises transmitting, by the second edge node, the copy to the web service and transmitting, by the web service, the copy to the first edge node.

4. The method of claim 1, further comprising: decrypting, at the first edge node, at least a portion of data in the copy of the data object using at least one cryptographic key obtained using cryptography information included in the copy of the data object, wherein the at least one cryptographic key was obtained by transmitting, by the first edge node, a request for the at least one cryptographic key to a key registrar service, the request for access comprising identity information associated with the first edge node and the cryptography information included in the copy of the data object.

5. The method of claim 1, wherein the data object comprises processing instructions for processing data in one or both of the data object and the copy of the data object.

6. The method of claim 5, wherein the processing instructions comprise: instructions for prompting a device for payment for processing the data in the data object; instructions for visualizing the data in the data object; instructions for recording updates to the data in the data object to a ledger, the ledger included in the data object; a temporal, geographic, device specific, or user specific limit for accessing the data in the data object; instructions for calling a compute resource for processing the data; instructions prohibiting transmission of the data object to one or more devices; instructions for viewing or processing the data according to a predefined sequence of processing steps; instructions for encrypting and decrypting at least a portion of the data; instructions for augmenting the data based on predefined algorithms or compute resources; or instructions for performing an action based on at least one condition being satisfied.

7. The method of claim 6, wherein the compute resource comprises a computer program configured to process the data.

8. The method of claim 6, wherein the at least one condition comprises: one or more conditions specified in the data object; the first edge node entering a certain geographic location; the edge node receiving a request to access the data; or a step associated with processing the data object at the first edge node being completed.

9. The method of claim 6, wherein the action comprises transmitting an alert to other edge nodes, users, and/or web services.

10. The method of claim 6, wherein the copy of the data object comprises a copy of the processing instructions.

11. The method of claim 10, further comprising: processing, at the first edge node, the decrypted portion of the data in the copy of the data object based on one or more of the processing instructions included in the copy of the data object.

12. The method of claim 11, wherein processing the decrypted portion of the data in the copy of the data object comprises at least one of: adding data to the data object, deleting at least a portion of the data from the data object, and modifying at least a portion of the data included in the data object.

13. The method of claim 11, wherein processing the decrypted portion of the data in the copy of the data object comprises at least one of: adding processing instructions to the copy of the data object, deleting processing instructions from the copy of the data object, and modifying processing instructions included in the copy of the data object.

14. The method of claim 11, further comprising:
determining, by the first edge node, that processing the copy of the data object resulted in a change to the data in the copy of the data object;
recording the change to the data to a ledger in the copy of the data object; and
transmitting an alert to the second edge node based on the change to the data.

15. The method of claim 14, further comprising:
determining that the data object includes a synchronization instruction to update the data object based on the change to the data in the copy of the data object; and
updating the data in the data object based on the change to the data in the copy of the data object.

16. The method of any one of claim 1, wherein the data object comprises a medical record, an electronic passport, an employee record, an electronic student identification, or a tax record.

17. A system for sharing data between edge nodes of a data communication network, the system comprising:
a first computing system comprising one or more processors and memory storing one or more computer programs that include computer instructions, which when executed by the one or more processors, cause the first computing system to:
transmit, by a first edge node a request for a data object to a web service;
a second computing system comprising one or more processors and memory storing one or more computer programs that include computer instructions, which when executed by the one or more processors, cause the second computing system to:
receive, by the web service, the request for the data object;
determine, by the web service, based on the request, an identity of a second edge node that has the data object, wherein the identity of the second edge node is determined from a database that associates data objects with edge nodes;
transmit, by the web service, a request to share the data object with the first edge node to the second edge node; and
a third computing system comprising one or more processors and memory storing one or more computer programs that include computer instructions, which when executed by the one or more processors, cause the third computing system to:
transmit, by the second edge node, a copy of the data object to the first edge node based on the request from the web service.

18. The system of claim 17, wherein transmitting, by the second edge node, the copy of the data object to the first edge node based on the request comprises transmitting, by the second edge node, the copy to the web service and transmitting, by the web service, the copy to the first edge node.

19. The system of claim 17, wherein the computer instructions stored in the memory of the first computing system, when executed by the one or more processors, cause the first computing system to:
decrypt, at the first edge node, at least a portion of data in the copy of the data object using at least one cryptographic key obtained using cryptography information included in the copy of the data object, wherein the at least one cryptographic key was obtained by:
transmitting, by the first edge node, a request for the at least one cryptographic key to a key registrar service, the request for access comprising identity information associated with the first edge node and the cryptography information included in the copy of the data object.

20. The system of claim 17, wherein the data object comprises processing instructions for processing data in one or both of the data object and the copy of the data object.
